(19) United States
(12) Patent Application Publication
(10) Pub. No.: US 2021/0057782 A1
(43) Pub. Date: Feb. 25, 2021

(54) BALANCING CIRCUIT WITH INTEGRAL CELL TEMPERATURE SENSING FOR A BATTERY

(71) Applicant: BAE Systems Controls Inc., Endicott, NY (US)

(72) Inventors: Darrin M. Weiss, Vestal, NY (US); Robert A. Hess, Seneca Falls, NY (US)

(73) Assignee: BAE Systems Controls Inc., Endicott, NY (US)

(21) Appl. No.: 16/547,035

(22) Filed: Aug. 21, 2019

(51) Int. Cl. H01M 10/42; H02J 7/00; H01M 10/6571; H01M 10/63; H01M 10/48; H01M 10/613; H01M 10/615; G01K 7/16

(52) U.S. Cl. CPC H01M 10/425; H02J 7/0021; H02J 7/0014; H01M 10/6571; H01M 2010/4271; H01M 10/486; H01M 10/613; H01M 10/615; G01K 7/16; H01M 10/63

(57) ABSTRACT

A rechargeable battery system including at least one energy storage cell having a positive terminal and a negative terminal, a resistive element and a circuit configured to allow current to flow through the resistive element. A monitoring circuit measures the current flow through, and a voltage produced across, the resistive element and calculates the resistance of the resistive element. The current flow through the resistive element produces heat by raising the temperature of the resistive element. The current flow through the resistive element may be managed by a balancing circuit. A current sense resistor may be connected in series with a balancing resistor and a transistor turns on a balancing operation through balancing resistor. The monitoring circuit may determine the temperature of the resistive element based on the calculated resistance. The battery monitoring circuit may activate a battery cooling system based on the temperature of the resistive element.

### BACKGROUND

The present disclosure is directed to self heating battery cells and more particularly, to battery cell temperature monitoring during cell balancing.

Battery cell monitoring and balancing techniques are known. One such technique for battery packs uses a multicell battery monitor that includes passive cell balancing for each cell.

Self-heating battery cells for electronics, transportation and grid energy storage are designed to improve performance at extreme conditions, especially sub-freezing temperatures. In one prior example, the battery cells have different levels of internal resistance that operate at different temperatures. In a subfreezing environment, the battery can exhibit high resistance that generates heat internally to warm up the battery quickly. Once the battery reaches normal operating temperatures, the battery can switch to a low resistance operating mode, thereby delivering superior power and energy despite operating in a very low ambient temperature.

### BRIEF SUMMARY

In one embodiment, a rechargeable battery system is disclosed, including at least one energy storage cell having at least one positive terminal and at least one negative terminal, at least one resistive element that is in contact with the at least one energy storage cell and a circuit configured to allow current to flow through the at least one resistive element. A monitoring circuit is configured to measure the current flow through, and a voltage produced across, the at least one resistive element and calculate the resistance of the at least one resistive element. In one embodiment, the current flow through the at least one resistive element produces heat by raising the temperature of the at least one resistive element. In one embodiment, the current flow through the at least one resistive element is managed by a balancing operation. In one embodiment, the at least one energy storage cell is a battery cell and the at least one resistive element includes a high heating terminal with an internal resistance. In one embodiment, a balancing circuit is provided for managing the balancing operation. In one embodiment, the balancing circuit includes a transistor connected to a balancing resistor. In one embodiment, the circuit configured to allow current to flow through the resistive element includes a current sense resistor connected in series with the balancing resistor. In one embodiment, the transistor turns on the balancing operation through balancing resistor. In one embodiment, the current managed by the balancing operation is selected to minimize the heat produced in the resistive element. In one embodiment, the monitoring circuit is configured to determine the temperature of the at least one resistive element based on the calculated resistance. In one embodiment, the battery monitoring circuit is configured to activate a battery cooling system based on the temperature of the resistive element.

In one embodiment, a method for monitoring the temperature of at least one energy storage cell having at least one positive terminal, at least one negative terminal and at least one resistive element that is in contact with the energy storage cell is disclosed. The method includes allowing current to flow through the resistive element, monitoring a circuit configured to measure the current flow through, and the voltage produced across, the at least one resistive element, calculating the resistance of the at least one resistive element and determining the temperature of the at least one resistive element based on the calculated resistance. In one embodiment, the method includes producing heat by raising the temperature of the at least one resistive element. In one embodiment, the method includes providing a balancing operation for managing the current flow through the at least one resistive element. In one embodiment, the method includes providing a balancing circuit for managing the balancing operation, the balancing circuit including a transistor connected to a balancing resistor, the transistor turning on the balancing operation through balancing resistor. In one embodiment, the method includes providing a circuit configured to allow current managed by a balancing operation to flow through the at least one resistive element, the circuit including a current sense resistor connected in series with the balancing resistor. In one embodiment, the method includes selecting the current managed by the balancing operation to minimize the heat produced in the at least one resistive element. In one embodiment, the method includes measuring the voltage across the current sense resistor and determining the balancing current flowing across the at least one resistive element. In one embodiment, the method includes activating a battery cooling system based on the temperature of the at least one resistive element.

### BRIEF DESCRIPTION OF THE DRAWINGS

FIG. 1 is a circuit diagram of a system for sensing the temperature of the internal heating foil of a battery cell in one embodiment of the present disclosure.

FIG. 2 is a flow diagram of a method for monitoring the temperature of at least one energy storage cell for sensing the temperature of the internal heating foil of a battery cell in one embodiment of the present disclosure.

FIG. 3 is a flow diagram of a method for monitoring the temperature of at least one energy storage cell for sensing the temperature of the internal heating foil of a battery cell that includes cell balancing in one embodiment of the present disclosure.

FIG. 4 illustrates a schematic of an example computer or processing system that may implement the system and method in one embodiment of the present disclosure.

Further features as well as the structure and operation of various embodiments are described in detail below with reference to the accompanying drawings. In the drawings, like reference numbers indicate identical or functionally similar elements.

### DETAILED DESCRIPTION

In one embodiment, the present disclosure provides a system and method for sensing the temperature of the internal heating foil of a self-heating cell as an integral part of the cell balancing circuit contained within a battery pack. In one embodiment, the temperature of the internal heating foil is accomplished via calculation of the resistance of the internal foil during the cell balancing operation. The temperature of the internal heating foil may also be determined at any other time when knowledge of the internal temperature of the cell is required.

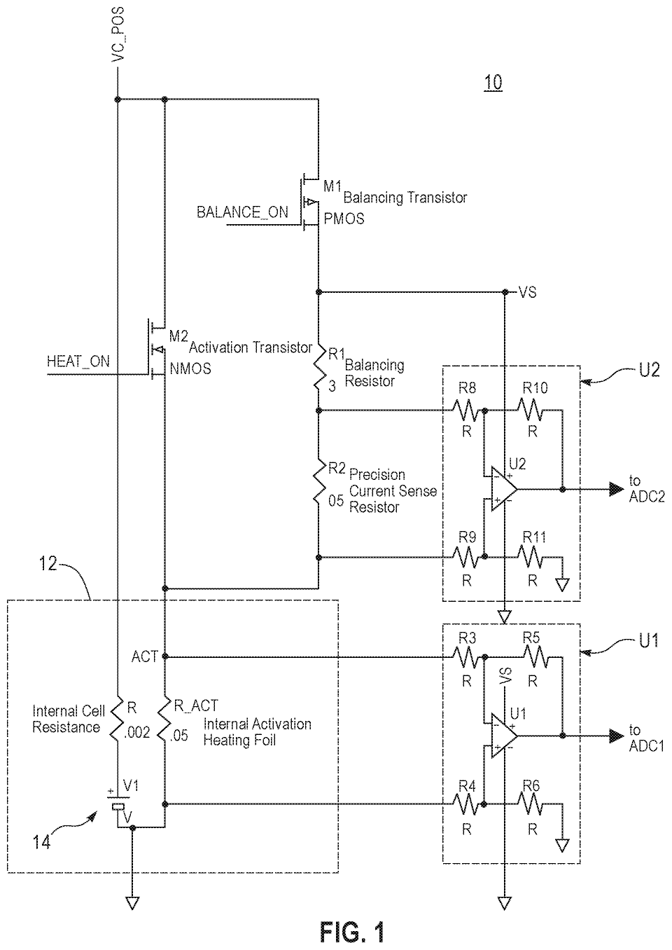

FIG. 1 is a circuit diagram of one embodiment of a system 10 for sensing the temperature of the internal heating foil of a self-heating battery cell. The system includes a self-heating battery cell 12, which includes an internal cell resistance Ri and an internal activation resistance Ract. A thermally activated switch 14 causes the internal resistance of the battery cell 12 to be Ri when closed and Ract when open. When cell heating is desired, the Ract resistor is connected to the positive terminal of the cell which causes rapid heating of the cell internal resistance heating foils.

MOSFET M1 is used to turn on the balancing function through resistor R1. MOSFET M2 is used to turn on the self-heating function. Resistor R2 is a precision current sense resistor. U1 and U2 are current sense amplifiers, such as a Texas Instruments INA 180. In the embodiment of FIG. 1, current sense amplifiers U1 and U2 are powered from the cell 12 whenever the balance transistor M1 is activated. In other embodiments, U1 and U2 could be separately powered.

MOSFET M2 and resistor R1 are components for implementing in passive cell balancing, with R1 setting the balance current. Initially, a battery stack may have fairly well matched cells. But over time, the cell matching degrades due to charge/discharge cycles, elevated temperature, and general aging. A weak battery cell will charge and discharge faster than stronger or higher capacity cells and thus it becomes the limiting factor in the run-time of a system. Passive balancing allows the stack to look like every cell has the same capacity as the weakest cell. Using a relatively low current, it drains a small amount of energy from high state of charge (SoC) cells during the charging cycle so that all cells charge to their maximum SoC. This is accomplished by using a switch and bleed resistor in parallel with each battery cell. The high SoC cell is bled off (power is dissipated in the resistor) so that charging can continue until all cells are fully charged.

In a preferred embodiment the current that flows during balancing is selected to minimize the heat produced in the activation resistor (I(balance)<<I(heating)).

During the balancing operation (or whenever it is desired to know the internal cell temperature), M1 is turned on to allow current to flow in series through the balancing resistor R1, the sense resistor R2, and the activation resistor Ract. The voltages across the sense resistor R2 and the activation resistor Ract are amplified by the current sense amplifiers U1 and U2. In one embodiment, the voltages are converted by an analog to digital converter for use by a battery monitor. One example of a battery monitor is the Analog Devices LTC6811, which includes an internal analog to digital converter.

The resistance of the activation resistor can then be calculated by the battery monitor from the following equations:

a. I(Ract)=V(Rsense)/Rsense Eq 1

b. Ract=I(Ract)/V(Ract) Eq 2

Once the resistance Ract is calculated, the temperature of the activation resistor Ract is calculated by the battery monitor from the known temperature behavior of the activation resistor Ract.

In one embodiment, there is a linear dependence of a Ni foil resistance on temperature. Other dependencies may exist for other materials used to construct the heating foils forming the activation resistor Ract.

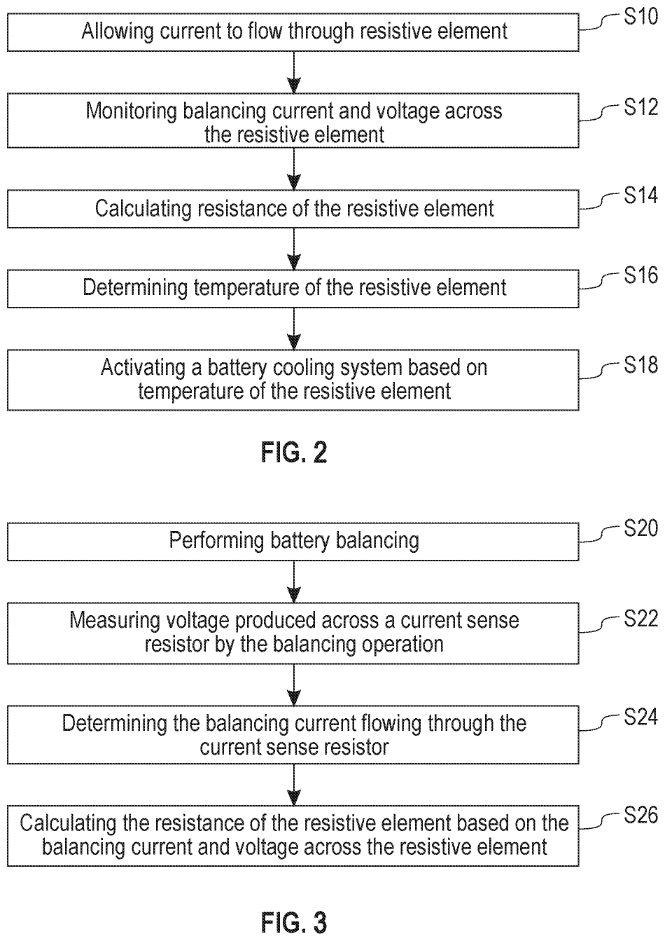

FIG. 2 is a flow diagram of one embodiment of a method for monitoring the temperature of at least one energy storage cell having at least one positive terminal, at least one negative terminal and at least one resistive element that is in electrical communication with the energy storage cell. The includes step S10 of allowing current to flow through resistive element and step S12 of monitoring balancing current and voltage across the resistive element. Step S14 includes calculating resistance of the resistive element and step S16 includes determining temperature of the resistive element. In one optional embodiment, the method may include step S18 of activating a battery cooling system based on temperature of the resistive element. In another option, the power drawn by a cell battery pack may be limited based on temperature of the resistive element.

In one embodiment, the current flowing through the resistive element is managed by a balancing operation. A balancing circuit may be provided for managing the balancing operation. The balancing circuit may include a transistor connected to a balancing resistor, the transistor turning on the balancing operation through balancing resistor. FIG. 3 is a flow diagram of one embodiment that includes step S20 of performing battery balancing. Step S22 includes measuring voltage produced across the current sense resistor by the balancing operation. Step S24 includes determining the balancing current flowing through the current sense resistor and step S26 of calculating the resistance of the resistive element based on the balancing current and voltage across the resistive element.

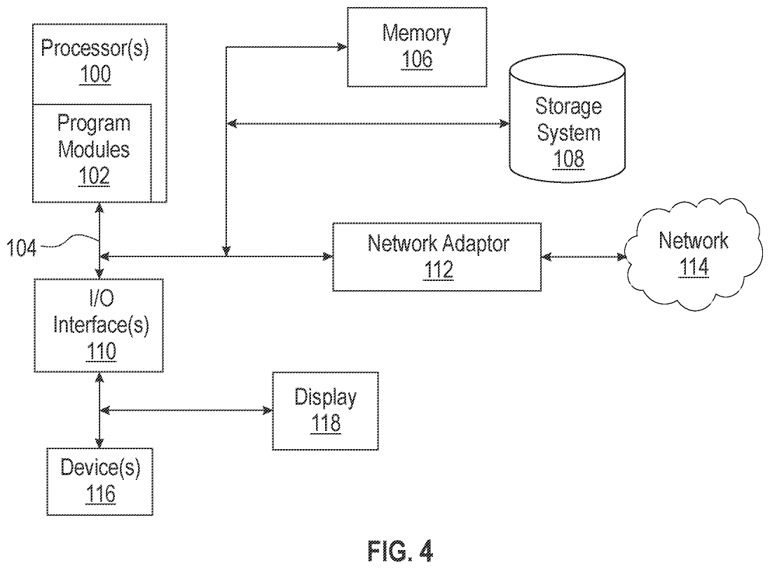

FIG. 4 illustrates a schematic of an example computer or processing system that may implement monitoring circuit and one or more steps of the method of one embodiment of the present disclosure. The computer system is only one example of a suitable processing system that may be used in implementing the system and method for sensing the temperature of the internal heating foil of a self-heating battery cell and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The components of computer system may include, but are not limited to, one or more processors or processing units 100, a system memory 106, and a bus 104 that couples various system components including system memory 106 to processor 100. The processor 100 may include a program module 102 that performs the methods described herein. The module 102 may be programmed into the integrated circuits of the processor 100, or loaded from memory 106, storage device 108, or network 114 or combinations thereof.

Bus 104 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

System memory 106 can include computer system readable media in the form of volatile memory, such as random access memory (RAM) and/or cache memory or others. Computer system may further include other removable/non-removable, volatile/non-volatile computer system storage media. By way of example only, storage system 108 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 104 by one or more data media interfaces.

The computer system may also communicate with one or more external devices 116 such as a keyboard, a pointing device, a display 118, etc.; one or more devices that enable a user to interact with computer system; and/or any devices (e.g., network card, modem, etc.) that enable computer system to communicate with one or more other computing devices. Such communication can occur via Input/Output (I/O) interfaces 110.

Still yet, the computer system can communicate with one or more networks 114 such as a local area network (LAN), a general wide area network (WAN), and/or a public network (e.g., the Internet) via network adapter 112. As depicted, network adapter 112 communicates with the other components of computer system via bus 104. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the network address configuration methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other components and functionality not reflected in the illustrations will be apparent in light of this disclosure, and it will be appreciated that other embodiments are not limited to any particular hardware or software configuration. Thus in other embodiments system may comprise additional, fewer, or alternative subcomponents as compared to those included in the example embodiments.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments disclosed herein. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure not be limited by this detailed description, but rather by the claims appended hereto. Future filed applications claiming priority to this application may claim the disclosed subject matter in a different manner, and may generally include any set of one or more elements as variously disclosed or otherwise demonstrated herein.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A rechargeable battery system comprising:
at least one energy storage cell having at least one positive terminal and at least one negative terminal;
at least one resistive element that is in contact with the at least one energy storage cell;
a circuit configured to allow current to flow through the at least one resistive element, the current flow through the at least one resistive element being managed by a balancing operation; and
a monitoring circuit configured to measure the current flow through, and a voltage produced across, the at least one resistive element and calculate a resistance of the at least one resistive element.

2. The rechargeable battery system of claim 1, wherein the current flow through the at least one resistive element produces heat by raising a temperature of the at least one resistive element.

3. The rechargeable battery system of claim 1, wherein the at least one energy storage cell is a battery cell and the at least one resistive element includes a high heating terminal with an internal resistance.

4. The rechargeable battery system of claim 1, further including a balancing circuit for managing the balancing operation.

5. The rechargeable battery system of claim 4, wherein the balancing circuit includes a transistor connected to a balancing resistor.

6. The rechargeable battery system of claim 5, wherein the circuit configured to allow current to flow through the resistive element includes a current sense resistor connected in series with the balancing resistor.

7. The rechargeable battery system of claim 5, wherein the transistor turns on the balancing operation through the balancing resistor.

8. The rechargeable battery system of claim 1, wherein the current managed by the balancing operation is selected to minimize the heat produced in the resistive element.

9. The rechargeable battery system of claim 1, wherein the monitoring circuit is configured to determine a temperature of the at least one resistive element based on the calculated resistance.

10. The rechargeable battery system of claim 9, wherein the monitoring circuit activates a battery cooling system based on the temperature of the resistive element.

11. The rechargeable battery system of claim 1, wherein the resistive element is an internal heating foil.

12. A method for monitoring a temperature of at least one energy storage cell having at least one positive terminal, at least one negative terminal and at least one resistive element that is in contact with the energy storage cell;
providing a balancing operation managing a current flow through the at least one resistive element.
monitoring a circuit configured to measure the current flow through, and the voltage produced across, the at least one resistive element;
calculating the resistance of the at least one resistive element; and
determining the temperature of the at least one resistive element based on the calculated resistance.

13. The method of claim 12, further comprising producing heat by raising the temperature of the at least one resistive element.

14. The method of claim 12 wherein the at least one energy storage cell is a battery cell and the at least one resistive element includes a high heating terminal with an internal resistance.

15. The method of claim 12, further comprising providing a balancing circuit for managing the balancing operation, the balancing circuit including a transistor connected to a balancing resistor, the transistor turning on the balancing operation through balancing resistor.

16. The method of claim 15, further comprising providing a circuit configured to allow current managed by a balancing operation to flow through the at least one resistive element, the circuit including a current sense resistor connected in series with the balancing resistor.

17. The method of claim 16, further comprising selecting the current managed by the balancing operation to minimize the heat produced in the at least one resistive element.

18. The method of claim 17, further including measuring the voltage across the current sense resistor and determining the balancing current flowing across the at least one resistive element.

19. The method of claim 12, further including activating a battery cooling system based on the temperature of the at least one resistive element.
